(19) United States
(12) Patent Application Publication
(10) Pub. No.: US 2026/0360118 A1
(43) Pub. Date: Nov. 12, 2026

(54) DETECTING OBJECTS IN IMAGES USING LANGUAGE AND VISION MODELS

(71) Applicant: INTERNATIONAL BUSINESS MACHINES CORPORATION, ARMONK, NY (US)

(72) Inventors: Kun Yan Yin, Ningbo (CN); Wen Wang, Beijing (CN); Chao Dong, Ningbo (CN); Hanbin Qi, Ningbo (CN); Yi Chen Zhong, Shanghai (CN)

(21) Appl. No.: 19/201,893

(22) Filed: May 7, 2025

(51) Int. Cl. G06V 10/77; G06F 40/279; G06F 40/40; G06V 10/776; G06V 20/70

(52) U.S. Cl. CPC G06V 10/7715; G06F 40/279; G06F 40/40; G06V 10/776; G06V 20/70

(57) ABSTRACT

Detecting one or more objects or features in an image by receiving a request that includes a target image, a text instruction describing a visual task to be performed on the target image, and one or more example images. The visual task is automatically divided into multiple sub-tasks by analyzing the text instruction and one or more annotations extracted from the example image. For each sub-task, the method generates relevant keywords and a set of augmented images. The target image is then analyzed separately based on the generated keywords and the augmented images to detect the objects or features in the target image. The method then combines the detected objects or features.

### TECHNICAL FIELD

The present disclosure generally relates to detecting objects and features in images, and more particularly, to detecting objects and features in images using language and vision models.

### BACKGROUND

### Description of the Related Art

Image analysis is salient in modern digital systems. Image analysis involves processing images to identify objects, features, or other meaningful elements present within the images. Image analysis commonly uses computer vision to interpret the visual information included within the images. Typically, computer vision employs visual models trained on large sets of example images to recognize objects, features, or other meaningful elements within the images.

Recent advancements in computer vision using deep learning techniques have significantly enhanced the capabilities of image analysis. Deep learning techniques involve neural network models trained using large domain-specific image datasets. The trained neural network models can detect complex visual patterns in images, thereby improving accuracy and reliability in identifying and classifying objects or features in the images.

Further developments in computer vision have led to the processing of images in combination with text-based information. Typically, computer vision models are used for extracting visual information by analyzing images, whereas large language models are used for processing the text-based information. Such combined models enable computer vision systems to handle tasks like image captioning, visual question answering, and other tasks involving object detection guided by text-based information.

Combining visual information extracted from the images with text-based information enables multimodal image processing systems to handle various tasks including industrial inspection, medical imaging, and similar applications. However, multimodal image processing systems often involve additional training to adapt to specific tasks or domains. This is typically limited to algorithm engineers and it is challenging to guide large language models in solving in-domain tasks.

### BRIEF SUMMARY

According to an embodiment of the present disclosure, a method for detecting one or more objects or features in a target image includes receiving a request having the target image, a text instruction describing a visual task associated with the target image, and at least one example image (also known as a “few shot”). The method includes dynamically splitting the visual task into a plurality of sub-tasks by analyzing the text instruction and one or more annotations obtained from the at least one example image. One or more keywords associated with each of the plurality of sub-tasks is generated based on the text instruction and the one or more annotations. A plurality of augmented images corresponding to each of the plurality of sub-tasks is also generated from the at least one example image. The one or more objects or features in the target image are detected by separately processing the plurality of augmented images and the one or more keywords. Each detection is assigned with a confidence score indicating an accuracy of the detection. The detected objects or features in the target image based on processing of the plurality of augmented images and the one or more keywords are then combined by identifying and removing duplicate detections and retaining only the detection having the highest confidence score among the duplicate detections.

In certain embodiments, detecting the objects or features in the target image include processing the augmented images and the target image using a large language model (LLM) and a large vision model (LVM) operating in a multimodal configuration. Each detected object or feature is assigned with one or more annotations and a confidence score.

According to an embodiment of the present disclosure, a computing device includes a processor and a memory in communication with the processor, storing computer program instructions that, when executed by the processor, cause the computing device to receive a request having a target image, a text instruction describing a visual task associated with the target image, and at least one example image. The computing device dynamically splits the visual task into a plurality of sub-tasks by analyzing the text instruction and one or more annotations obtained from the example image. The computing device then generates one or more keywords associated with each sub-task based on the text instruction and the annotations. The computing device also generates a plurality of augmented images corresponding to each sub-task from the example image. The computing device detects one or more objects or features in the target image by separately processing the augmented images and the keywords, each detection being associated with a confidence score. The computing device then combine the detected objects or features by identifying and removing duplicate detections and retaining the detection having the highest confidence score among the duplicate detections.

According to one embodiment, the computer program instructions when executed using the processor cause the computing device to extract the one or more annotations from the at least one example image using a large vision model (LVM) operating in a multimodal configuration that includes the LVM and a large language model (LLM).

According to one embodiment, a computer program product includes one or more computer-readable storage devices storing instructions that, when executed by a processor, cause the processor to receive a request comprising a target image, a text instruction describing a visual task associated with the target image, and at least one example image. The instructions cause the processor to dynamically split the visual task into a plurality of sub-tasks by analyzing the text instruction and one or more annotations obtained from the example image. The processor may generate one or more keywords associated with each sub-task based on the text instruction and annotations and generate a plurality of augmented images from the example image corresponding to each sub-task. The processor may detect one or more objects or features in the target image by separately processing the augmented images and the keywords, wherein each detection is associated with a confidence score. The processor may then combine the detected objects or features by identifying and removing duplicate detections and retaining the detection having the highest confidence score among the duplicate detections.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 depicts a block diagram of a network of data processing systems, in accordance with an illustrative embodiment.

FIG. 2 depicts a block diagram of a computing environment, in accordance with an illustrative embodiment.

FIG. 3 depicts a block diagram illustrating a system for detecting one or more objects or features in a target image, in accordance with an illustrative embodiment.

FIG. 4 depicts a flowchart for detecting one or more objects or features in a target image, in accordance with an illustrative embodiment.

FIG. 5 illustrates an example of dynamically splitting a visual task into multiple simpler sub-tasks, in accordance with an exemplary embodiment.

FIG. 6 depicts an exemplary diagram illustrating the generation of one or more keywords for each sub-task, in accordance with an exemplary embodiment.

FIG. 7 depicts an exemplary diagram illustrating the generation of a plurality of augmented images from an example image, in accordance with an exemplary embodiment.

FIG. 8 depicts an exemplary diagram illustrating the detection of objects or features in a target image, in accordance with an exemplary embodiment.

### DETAILED DESCRIPTION

### Overview

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring parts of the present teachings.

The teachings herein relate to a method for detecting one or more objects or features in a target image. The method includes receiving a request that includes the target image, a text instruction describing a visual task associated with the target image, and at least one example image. The method further dynamically divides the visual task into multiple sub-tasks by analyzing the text instruction and annotations extracted from the example image. Based on the text instruction and extracted annotations, the method generates multiple keywords for each sub-task. The method then generates several augmented images for each sub-task by modifying the example image using image augmentation techniques. Subsequently, the method detects one or more objects or features in the target image by separately processing the augmented images and the keywords. Each detection is associated with a confidence score indicating an accuracy of the detection. Finally, the method combines the detected objects or features by identifying and eliminating duplicate detections and retains only the detection that has the highest confidence score among the duplicate detections. The method provides a simple and efficient way to detect objects or features in images using only a few example images and plain language instructions. Unlike traditional computer vision systems that require large, domain-specific datasets for training, the present method adapts to new visual tasks without retraining, making it more flexible and quicker to deploy in changing environments. The method does not require the users to have any technical expertise to generate text instructions and can use plain language to describe the visual task. The method automatically breaks the visual task into simpler sub-tasks, generates appropriate keywords and annotations for the objects or features of interest, and produces multiple augmented images or visual few shots for separately detecting the objects and features in the target image to increase detection accuracy. Further, the method reduces manual effort, involves less computing power and improves the accuracy of detections in specialized domains such as industrial inspection, especially when limited training data is available.

In embodiments, dynamically splitting the visual task into sub-tasks includes analyzing the text instruction and the annotations obtained from the example image using a large language model (LLM). The use of LLM to divide the complex visual task into manageable sub-tasks allows better interpretation of the visual task, especially in cases where the task is not clearly defined in the text instruction received from the user.

In embodiments, the keywords are generated by extracting terms related to the objects or features from the text instruction and the annotations in the example image using LLM. The use of LLM to generate keywords based on semantics that closely match the text instructions from the user and the annotations extracted from the example image makes the object and feature detection more accurate, especially in cases where the target image is complex or when the text instructions received from the user are unclear.

In embodiments, annotations are extracted from the example image by using a large vision model (LVM) together with a large language model (LLM) operating in a multimodal configuration. This automated process combines visual and language information to reliably extract the annotations from the image, thereby eliminating the need for manual annotation.

In embodiments, the method detects objects or features in the target image based on the one or more keywords by performing text-to-target detection with a vocabulary-based object detection method. The vocabulary-based object detection method matches the keywords to semantic terms, allowing the method to recognize new objects or features at runtime without relying on a fixed set of labels or object annotations. As such, the proposed detection method can adapt to a variety of tasks and reduces the need for domain-specific training of the large vision model.

In embodiments, multiple augmented images are created from the example image by applying image-augmentation techniques such as rotation, cropping, zooming, or image generation with models such as stable diffusion. Further processing multiple augmented images or visual examples or visual few shots enable the large vision model to detect objects or features from different viewpoints. The additional detections from the visual examples improve overall accuracy when the target image shows variations in angle, illumination, or partial occlusion, which is especially beneficial when only limited training data are available.

In embodiments, the method detects objects or features by processing the augmented images together with the target image using the large vision model (LVM) and the large language model (LLM) in a multimodal configuration. Each detection includes appropriate annotations of the objects and features and a confidence score indicating an accuracy of the detection. Utilizing both the LVM and LLM models together enables the method to perform more accurate detections with fewer mistakes.

In embodiments, the detection may also include jointly processing the annotations, the generated keywords, and the text instruction receive from the user using both the LVM and LLM in the multimodal configuration. The processing of all these inputs together gives the multimodal configuration a better understanding of the user's request, distinguish similar or closely related objects, detect small details or features in the images, and present the detected objects or features in the targeted image that closely match the requirements of the user.

In embodiments, the method combines the detection results by applying a non-maximum suppression (NMS) technique. The application of the NMS technique removes duplicate detections and keeps only the detection with the highest confidence score when detections overlap, which reduces redundant outputs, ensures cleaner and more interpretable detection results and improves both accuracy and processing efficiency in real-time use.

In embodiments, the method further refines the results obtained from the detections by iteratively removing remaining duplicate detections until only unique high-confidence results remain. This iterative refinement improves the reliability of the detections, especially in complex scenarios where initial elimination of the duplicate detections may miss slight overlaps. The iterative step ensures that the output includes the most reliable detections with minimal or zero duplicate results.

According to one embodiment, a computing device includes a processor and a memory that stores computer program instructions. The stored computer program instructions when executed allow the computing device to receive a request that includes a target image, a text instruction describing a visual task related to the target image, and at least one example image. The computing device then analyzes the instruction and annotations extracted from the example image to split the visual task into multiple sub-tasks. For each sub-task, the computing device generates a set of keywords based on the text instruction and the extracted annotations. The computing device also creates multiple augmented versions of the example image for each sub-task. The computing device detects objects or features in the target image by separately processing the augmented images and the generated keywords. The computing device also assigns a confidence score to each detection to indicate how accurate is the corresponding detection. The computing device then combines the detected objects or features by identifying and removing duplicate detections or results and keeping only the detection or result with the highest confidence score among the duplicate detections or results. The computing device provides an efficient way to detect objects or features in images using one or very few example images and natural language instructions. Traditional computer vision systems require large, domain-specific training datasets to train appropriate computer vision models to detect objects and features in images, whereas the proposed computing device can handle new visual tasks without large training datasets or model retraining, which improves adaptability to new use cases, supports faster implementation in dynamic environments, and minimizes the time and effort required for preparing the relevant datasets for retraining. Furthermore, the computing device enables users to describe visual tasks using plain language, without the need for technical expertise or a specific prompt format. The automatic splitting of the visual task into simpler sub-tasks reduces processing complexity and computing requirements. In addition, the computing device automatically generates relevant keywords and annotations, reducing the need for manual input. The multiple augmented images or visual few shots generated from the example image helps to improve the accuracy of the detections. Overall, the computing device helps to reduce reliance on large datasets for retraining and improve accuracy in domain specific tasks.

In embodiments, the computing device uses a large language model (LLM) to analyze the text instruction and the annotations extracted from the example image to split the visual task into multiple sub-tasks. The use of LLM to divide the complex visual task into manageable sub-tasks allows better interpretation of the visual task, especially in cases where the task is not clearly defined in the text instruction received from the user.

In embodiments, the device extracts annotations from the example image using a large vision model (LVM) that works together with the LLM in a multimodal configuration. This enables the computing device to combine visual and language information to reliably extract the annotations from the example image, thereby eliminating the need for manual annotation.

In embodiments, the computing device generates the keywords by using the LLM to extract relevant terms from the text instruction and the annotations extracted from the example image. The use of LLM to generate keywords based on semantics that closely match with the text instructions from the user and the annotations extracted from the example image, makes the object and feature detection using the computing device more accurate, especially when the target image is complex and when the text instructions received from the user is unclear.

In embodiments, the augmented images are generated by applying image augmentation techniques to the example image. The image augmentation techniques may include rotation, cropping, zooming, or image generation using a model such as stable diffusion. This enables the computing device to further process the augmented images to enable the large vision model to detect objects or features from different viewpoints. The additional detections from the visual examples improve overall accuracy when the target image shows variations in angle, illumination, or partial occlusion, which is especially beneficial when only limited training data are available to the computing device.

In embodiments, the computing device detects the objects or features by processing the augmented images and the target image using both the LVM and the LLM in a multimodal configuration. The computing device further assigns a confidence score to each detection. Utilizing both the LVM and LLM models together enable the computing device to perform more accurate detections and fewer mistakes. This further allows the computing device to be used in areas that involve accurate image detections, such as factory quality checks or medical image reviews.

According to an embodiment of the present disclosure, a computer program product includes one or more storage devices that include program instructions. The program instructions, executable by a processor, includes specific program instructions to receive a request that includes a target image, a text instruction, and one or more example images. The program instructions further include instructions to split the task into sub-tasks by analyzing the text instruction and the annotations extracted from the received example image. The program instructions further include instructions to generate keywords associated with each of the sub-tasks based on the text instruction and the extracted annotations. The program instructions further include instructions to generate augmented images for each sub-task. the augmented images are generated from the example image. The program instructions further include instructions to detect objects or features in the target image by separately processing the augmented images, and the keywords. Each of the detection is associated with a confidence score indicating an accuracy of the detection. The program instructions further include instructions to combine the objects or features detected by processing the augmented images and the keywords, by identifying and removing duplicate detections and retaining the detection having the highest confidence score among the duplicate detections. The computer program product provides a simple and efficient way to detect objects or features in images using only a few example images and plain language instructions. Unlike traditional computer program product for computer vision systems that require large, domain-specific datasets for training, the present product adapts to new visual tasks without retraining, making it more flexible and quicker to deploy in changing environments. The users of this product do not need any technical expertise to generate text instructions and can use plain language to describe the visual task. The product automatically breaks the visual task into simpler sub-tasks, generates appropriate keywords and annotations for the objects or features of interest, and produces multiple augmented images or visual few shots for separately detecting the objects and features in the target image to increase detection accuracy. The product reduces manual effort and computing requirements and improves the accuracy of detections in specialized domains such as industrial inspection, especially when limited training data is available.

In embodiments, the program instructions include instructions to process the augmented and target images using a large vision model operating in a multimodal configuration that includes a large language model. This helps computer program product to automate the process of combining visual and language information to reliably extract the annotations from the example image, thereby eliminating the need for manual annotation.

In embodiments, the program instructions include instructions to use a vocabulary-based object detection method to detect the objects or features from the target image using the generated keywords. The vocabulary-based object detection used in the program matches the keywords to semantic terms, allowing the program to recognize new objects or features at runtime without relying on a fixed set of labels or object annotations. As such, the proposed program can adapt to a variety of tasks and reduces the need for domain-specific training of the large vision model.

In embodiments, the program instructions include instructions to use a non-maximum suppression (NMS) method to remove duplicate detections and keep only the detection or result with the highest confidence score among the duplicate detections. The application of the NMS technique removes duplicate detections and keeps only the detection with the highest confidence score when detections overlap, which reduces redundant outputs, ensures cleaner and more interpretable detection results and improves both accuracy and processing efficiency in real-time use.

Computer vision models are commonly used in many image processing applications to detect objects or features in images. These computer vision models are typically trained with large, domain-specific datasets prior to being used for detecting objects or features in images. However, training such computer vision models typically requires extensive data preparation and retraining when applied to new tasks or contexts. Some of the existing computer vision models have shown good object or feature detection performance in well-defined environments, allowing the models to be used in dynamic user-specific scenarios, which often involve the user putting considerable manual effort and also requiring the user to have considerable technical expertise to provide a text instruction to perform a visual task using the model. Typically, the text instructions is given in a particular format, which involves the user to have considerable knowledge about the model and the input expected by the model and the processing methods to achieve a reliable or accurate detection result using the model. However, in most scenarios, the users may not be technically proficient, rather they may be clear on the final output they expect from the model. Such users may give the text instructions in natural language, which makes the task challenging for the existing models such as those using vision language models (VLM), as the text instructions are provided using plain-language instructions and the VLM model may not be trained to interpret the instructions.

The present disclosure describes a method that enables object or feature detection in images by integrating both visual and language inputs through a multimodal configuration. The method can receive a request from a user, where the requests may include a target image (an image to be detected, such as an image that is to be described or classified or whose contents are to be described or classified), a text instruction in natural language, and an example image (also known as a “few shot” in a machine learning approach wherein models learn to recognize patterns and make predictions using a small number of training examples, such as one to five per class). The method automatically divides the visual task into manageable sub-tasks. The method then extracts relevant keywords from the natural language text instruction and annotations extracted from the example image, generates several augmented images from the example image for comparison, and performs parallel object or feature detection in the target image based on the augmented images using a computer vision model and using the keywords using a large language model. The method then combines both detections and filters duplicate detections for the most accurate detection results. The method can be used for performing dynamic user-defined tasks with minimal training of the models operating in the multimodal configuration or manual assistance. This allows the method to be used in diverse domains and allows the users to interact with the method using natural language or plain text and involves minimal computing power.

Importantly, although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations. Accordingly, one or more of the methodologies discussed herein may obviate a need for special algorithmic engineers. This may have the technical effect of providing multiple-modal chat services which can be used for specific in-domain scenarios where there has not been prior training by some language vision model. This may further reduce the use of computing resources due to less training. Examples of such computing resources include, without limitation, processor cycles, network traffic, memory usage, storage space, and power consumption. It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

The illustrative embodiments are described with respect to certain types of machines. The illustrative embodiments are also described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures therefor, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

### Example Data Processing Environment

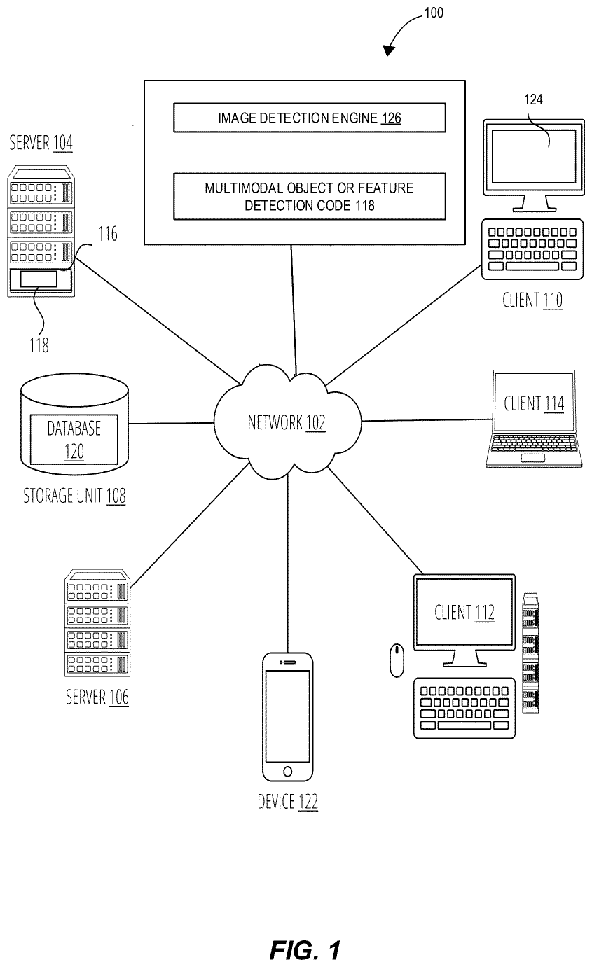

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Client 110, client 112, client 114 are also coupled to network 102. A data processing system, such as clients (client 110, client 112, client 114), image detection engine 126 and device 122 may include data and may have software applications or software tools executing thereon. Server 104 and server 106 may include one or more GPUs (graphics processing units) for statistical analysis or machine learning.

Only as an example, and without implying any limitation to such architecture, FIG. 1 depicts certain components that are usable in an example implementation of an embodiment. For example, servers and clients are only examples and not to imply a limitation to a client-server architecture. As another example, an embodiment can be distributed across several data processing systems and a data network as shown, whereas another embodiment can be implemented on a single data processing system, which are all within the scope of the illustrative embodiments.

Data processing systems (image detection engine 126, server 104, server 106, client 110, client 112, client 114 and device 122) also represent example nodes in a cluster, partitions, and other configurations suitable for implementing an embodiment.

Server 104, server 106, storage unit 108, client 110, client 112, client 114, device 122, image detection engine 126 may couple to network 102 using wired connections, wireless communication protocols, or other suitable data connectivity. Client 110, client 112 and client 114 may be, for example, personal computers or network computers.

In the depicted example, the servers may provide data, such as boot files, operating system images, and applications to client 110, client 112, and client 114. Client 110, client 112 and client 114 may be clients to servers in this example. Client 110, client 112 and client 114 or some combination thereof, may include their own data, boot files, operating system images, and applications. Data processing environment 100 may include additional servers, clients, and other devices that are not shown. Server 104 may include a server application 116 that may be configured to implement one or more of the functions described herein in accordance with one or more embodiments. Server application 116, client application 124 and/or image detection engine 126 may include multimodal object or feature detection code 118, configured for detecting one or more objects or features in a target image. In some embodiments, image detection engine 126 may be or form a part of a server or client described herein.

Device 122 is an example of a device described herein. For example, device 122 can take the form of a smartphone, a tablet computer, a laptop computer, client 110 in a stationary or a portable form, or any other suitable device. Any software application described as executing in another data processing system in FIG. 1 can be configured to execute in device 122 in a similar manner. Any data or information stored or produced in another data processing system in FIG. 1 can be configured to be stored or produced in device 122 in a similar manner. Database 120 of storage unit 108 may store one or more term data samples for computations herein.

The data processing environment 100 may also be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service-oriented architecture where interoperable software components distributed across a network may be packaged together as coherent business applications. Data processing environment 100 may also take the form of a cloud and employ a cloud computing model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

Various embodiments of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 includes an example of an environment for the execution of at least some of the computer code involved in performing the inventive methods, such as multimodal object or feature detection code 118. In addition to multimodal object or feature detection code 118, computing environment 200 includes, for example, Computer 202, wide area network 228 (WAN), end user device 230 (EUD), remote server 232, public cloud 240, and private cloud 236. In this embodiment, Computer 202 includes processor set 204 (including processing circuitry 206 and cache 208), communication fabric 210, volatile memory 212, persistent storage 214 (including operating system 216 and multimodal object or feature detection code 118, as identified above), peripheral device set 218 (including user interface (UI) device set 220, storage 222, and Internet of Things (IoT) sensor set 224), and network module 226. Remote server 232 includes remote database 234. Public cloud 240 includes gateway 238, cloud orchestration module 242, host physical machine set 246, virtual machine set 244, and container set 248.

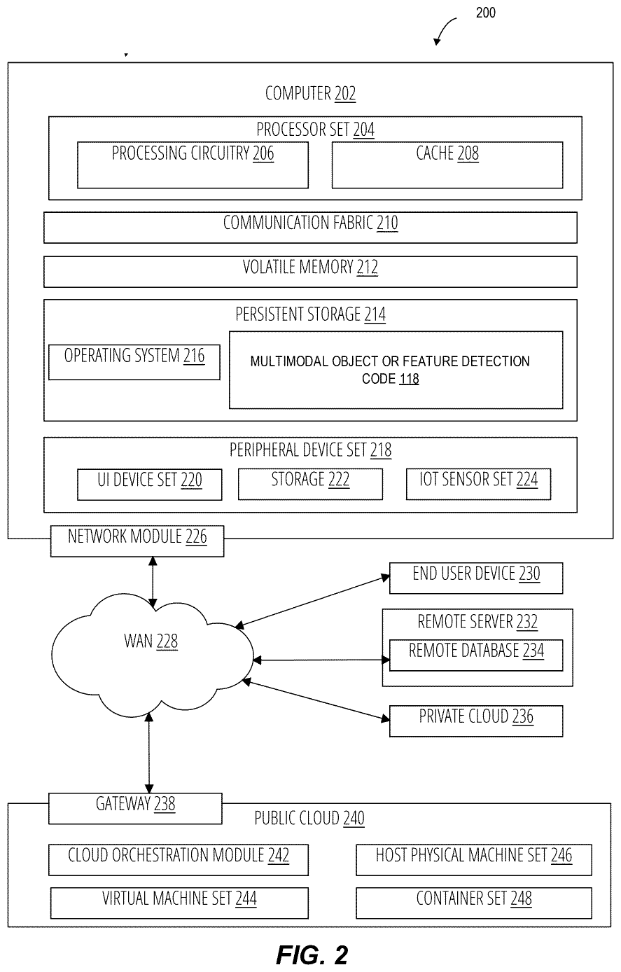

Computer 202 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 234. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically Computer 202, to keep the presentation as simple as possible. Computer 202 may be located in a cloud, even though it is not shown in a cloud in FIG. 2. On the other hand, Computer 202 is not required to be in a cloud except to any extent as may be affirmatively indicated.

Processor set 204 includes one, or more, computer processors of any type now known or to be developed in the future. Processing circuitry 206 may be distributed over multiple packages, for example, multiple, coordinated integrated circuit chips. Processing circuitry 206 may implement multiple processor threads and/or multiple processor cores. Cache 208 is memory that is located in the processor chip package(s) and is typically used for data or code that should be available for rapid access by the threads or cores running on processor set 204. Cache memories are typically organized into multiple levels depending upon relative proximity to the processing circuitry. Alternatively, some, or all, of the cache for the processor set may be located “off chip.” In some computing environments, processor set 204 may be designed for working with qubits and performing quantum computing.

Computer readable program instructions are typically loaded onto Computer 202 to cause a series of operational steps to be performed by processor set 204 of Computer 202 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 208 and the other storage media discussed below. The program instructions, and associated data, are accessed by processor set 204 to control and direct performance of the inventive methods. In computing environment 200, at least some of the instructions for performing the inventive methods may be stored in multimodal object or feature detection code 118 in persistent storage 214.

Communication fabric 210 is the signal conduction path that allows the various components of Computer 202 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In Computer 202, the volatile memory 212 is located in a single package and is internal to Computer 202, but, alternatively or additionally, the volatile memory may be distributed over multiple packages and/or located externally with respect to Computer 202.

Persistent storage 214 is any form of non-volatile storage for computers that is now known or to be developed in the future. The non-volatility of this storage means that the stored data is maintained regardless of whether power is being supplied to Computer 202 and/or directly to persistent storage 214. Persistent storage 214 may be a read only memory (ROM), but typically at least a portion of the persistent storage allows writing of data, deletion of data and re-writing of data. Some familiar forms of persistent storage include magnetic disks and solid-state storage devices. Operating system 216 may take several forms, such as various known proprietary operating systems or open-source Portable Operating System Interface-type operating systems that employ a kernel. The code included in multimodal object or feature detection code 118 typically includes at least some of the computer code involved in performing the inventive methods.

Peripheral device set 218 includes the set of peripheral devices of Computer 202. Data communication connections between the peripheral devices and the other components of Computer 202 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 220 may include components such as a display screen, speaker, microphone, wearable devices (such as goggles and smart watches), keyboard, mouse, printer, touchpad, game controllers, and haptic devices. Storage 222 is external storage, such as an external hard drive, or insertable storage, such as an SD card. Storage 222 may be persistent and/or volatile. In some embodiments, storage 222 may take the form of a quantum computing storage device for storing data in the form of qubits. In embodiments where Computer 202 is required to have a large amount of storage (for example, where Computer 202 locally stores and manages a large database) then this storage may be provided by peripheral storage devices designed for storing very large amounts of data, such as a storage area network (SAN) that is shared by multiple, geographically distributed computers. IoT sensor set 224 is made up of sensors that can be used in Internet of Things applications. For example, one sensor may be a thermometer and another sensor may be a motion detector.

Network module 226 is the collection of computer software, hardware, and firmware that allows Computer 202 to communicate with other computers through WAN 228. Network module 226 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 226 are performed on the same physical hardware device. In other embodiments (for example, embodiments that utilize software-defined networking (SDN)), the control functions and the forwarding functions of network module 226 are performed on physically separate devices, such that the control functions manage several different network hardware devices. Computer readable program instructions for performing the inventive methods can typically be downloaded to Computer 202 from an external computer or external storage device through a network adapter card or network interface included in network module 226.

WAN 228 is any wide area network (for example, the internet) capable of communicating computer data over non-local distances by any technology for communicating computer data, now known or to be developed in the future. In some embodiments, the WAN 228 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 230 is any computer system that is used and controlled by an end user (for example, a customer of an enterprise that operates Computer 202) and may take any of the forms discussed above in connection with Computer 202. EUD 230 typically receives helpful and useful data from the operations of Computer 202. For example, in a hypothetical case where Computer 202 is designed to provide a recommendation to an end user, this recommendation would typically be communicated from network module 226 of Computer 202 through WAN 228 to EUD 230. In this way, EUD 230 can display, or otherwise present, the recommendation to an end user. In some embodiments, EUD 230 may be a client device, such as thin client, heavy client, mainframe computer, desktop computer and so on.

Remote server 232 is any computer system that serves at least some data and/or functionality to Computer 202. Remote server 232 may be controlled and used by the same entity that operates Computer 202. Remote server 232 represents the machine(s) that collect and store helpful and useful data for use by other computers, such as Computer 202. For example, in a hypothetical case where Computer 202 is designed and programmed to provide a recommendation based on historical data, then this historical data may be provided to Computer 202 from remote database 234 of remote server 232.

Public cloud 240 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 240 is performed by the computer hardware and/or software of cloud orchestration module 242. The computing resources provided by public cloud 240 are typically implemented by virtual computing environments that run on various computers making up the computers of host physical machine set 246, which is the universe of physical computers in and/or available to public cloud 240. The virtual computing environments (VCEs) typically take the form of virtual machines from virtual machine set 244 and/or containers from container set 248. It is understood that these VCEs may be stored as images and may be transferred among and between the various physical machine hosts, either as images or after instantiation of the VCE. Cloud orchestration module 242 manages the transfer and storage of images, deploys new instantiations of VCEs and manages active instantiations of VCE deployments. Gateway 238 is the collection of computer software, hardware, and firmware that allows public cloud 240 to communicate through WAN 228.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 236 is similar to public cloud 240, except that the computing resources are only available for use by a single enterprise. While private cloud 236 is depicted as being in communication with WAN 228, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 240 and private cloud 236 are both part of a larger hybrid cloud.

### Example Architecture

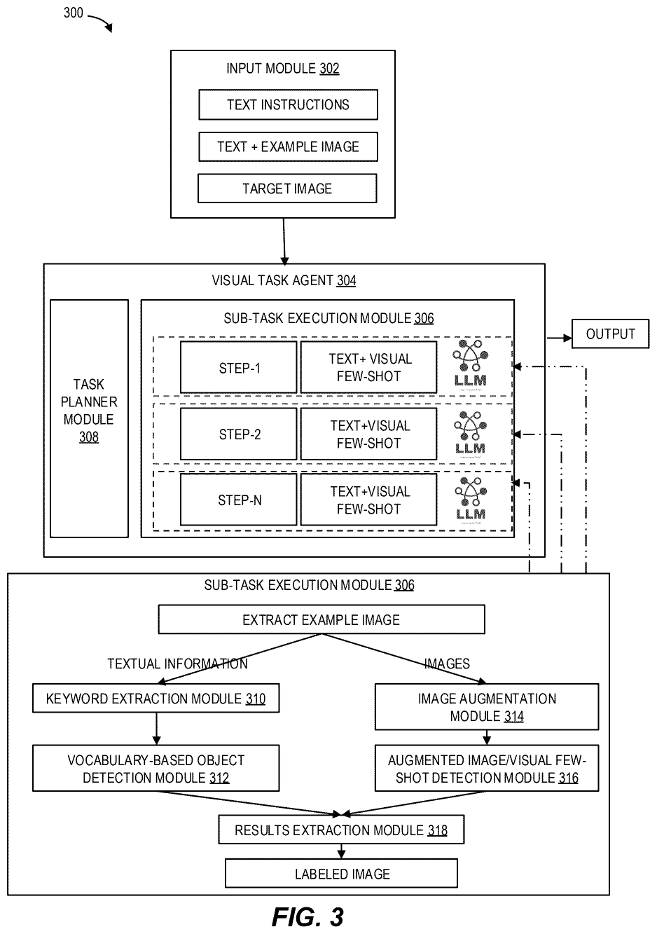

Reference now is made to FIG. 3, which depicts a detailed block diagram illustrating a system 300 for detecting one or more objects or features in a target image according to an illustrative embodiment. The system 300 includes an input module 302, a visual task agent 304, and a sub-task execution module 306. The input module 302 receives a request related to a visual task associated with the target image from a user. The request typically includes text instructions or a prompt, an example image, and the target image. The text instructions describe the visual task that the user wants to perform on the target image in natural language or plain text without any specific format. The system 300 enables all types of users, including users without any technical expertise in the field of image processing and without specific formatting knowledge to send the requests using natural language or plain text for further processing. The example image provided by the user as part of the request typically includes labels or annotations which may be relevant to the visual task. In some instances, the user may provide multiple example images, which may or may not include labels or annotations or texts. In such situations, the system 300 is configured to automatically process the example images to extract relevant annotations using a large language model (LLM).

The system 300 also includes a visual task agent 304 that includes a task planner module 308. The task planner module 308 dynamically divides the visual task into multiple simpler sub-tasks, which can be easily understood by the system 300 based on analyzing the text instructions and the annotations extracted from the example image. In one embodiment, the task planner module 308 uses the large language model to effectively analyze and interpret the text instructions and the annotations. Based on the analysis, the task planner module 308 dynamically splits the visual task into simpler sub-tasks (step-1, step-2, . . . , step-n), each of which can be effectively processed by the system 300 with minimal computational resources without affecting the accuracy of the detection results.

In one embodiment, the visual task agent 304 is further configured to generate visual examples or few-shot images along with appropriate annotations or textual information for each of the sub-tasks from the example image provided by the user. The visual few shots along with the textual information, which may include keywords and annotations that are directly extracted from the text instructions or the example image received from the user, are typically generated using the LLM and/or LVM operating in the multimodal configuration. Associating each sub-tasks with the appropriate visual examples or few-shot images with appropriate annotations enables the visual task agent 304 to clearly understand the sub-tasks. Typically, the annotations extracted from the visual few shots include an object or feature identifier such as the name of the object or the feature along with appropriate text describing one or more characteristics of the object or feature. This further assists the system 300 by providing more tips or clues to the LLM and LVM models operating in the multimodal configuration to understand the requirements of the user from the text instruction and the example image with the generated annotations to accurately identify the objects or features in the target image.

The example image or the visual few shots with appropriate annotations generated for each of the sub-tasks is fed to the sub-task execution module 306 as inputs for accurate object and feature detection in the respective sub-tasks. This enables the sub-task execution module 306 to effectively perform object or feature detection, significantly improving accuracy, especially in visually ambiguous or complex scenarios.

The sub-task execution module 306 is configured to detect objects or features from the target image based on the textual information such as the text instruction received from the users, annotations and generated feature descriptions and from the images, such as the example images and visual few shots. The sub-task execution module 306 includes several sub-modules, including a keyword extraction module 310 and a vocabulary-based object detection module 312 for detecting the objects and features in the target image based on the textual information, and an image augmentation module 314 and an augmented image/visual few-shot detection module 316 for detecting the objects and features in the target image based on the images. The sub-task execution module 306 further includes a results extraction module 318 for combining the detections or results received by parallel processing of the textual information and the images and refining the results by removing any duplicate objects/detections.

The keyword extraction module 310 analyzes the text instructions provided by the user and the annotations extracted from the example image or visual few shots using the large language model to extract the most relevant and descriptive keywords. The descriptive keywords provide clear semantic cues for subsequent vocabulary-based detection, thereby significantly enhancing clarity, detection accuracy, and ease of object or feature identification.

The vocabulary-based object detection module 312 utilizes the extracted keywords to perform object or feature detection within the target image using a text-to-target detection method. In one embodiment, the text-to-target detection method used by the vocabulary-based object detection module 312 includes models such as Grounding-DINO. The model combines a transformer-based detector with grounded pre-training, allowing detection of objects based solely on concise semantic terms rather than requiring extensive descriptive inputs. The vocabulary-based object detection module 312 uses only important information in the form of the most relevant keywords and does not require long and descriptive text instructions typically given by the user. This targeted detection capability efficiently identifies the objects or features in new or untrained categories without requiring additional training.

The image augmentation module 314 generates multiple augmented images from the example image or visual few shots associated with the sub-task using various image augmentation techniques. The various image augmentation techniques include normal transfer methods such as rotation, cropping, zooming, and stable diffusion techniques such as generating alternate images, for example generate images with different backgrounds or features. These automated image augmentations create several augmented images or further visual few shots, each potentially differing slightly in labeling from the example image or visual few shots associated with the sub-task. Such variations enhance detection effectiveness, allowing the augmented image or visual few-shot detection model to accurately recognize objects or features in the target image under diverse visual conditions such as changes in viewing angles, scales, or occlusions etc.

The augmented image or visual few-shot detection module 316 independently compares the augmented images with the target image to detect objects or features using advanced detection using the LVM model. Typical examples of LVM models include architectures such as DE-ViT. This model uses a region-propagation mechanism and learnable spatial integral layers to accurately identify objects and features related to the request from the user without the need for extensive fine-tuning of the large visual model or the results. Utilizing augmented images or visual few shots improves detection reliability, which is particularly beneficial when initial training data is limited or when features in the target image for which corresponding detections are not present in the example image. The objects or features detected in parallel using both the above-mentioned vocabulary-based object detection module 312 and the augmented image or visual few-shot detection module 316 enhance the overall accuracy and reliability of detection, especially when the data associated with the request is limited or scarce.

The results extraction module 318 merges the outputs from both the vocabulary-based object detection module 312 and the augmented image or visual few-shot detection module 316. The results extraction module 318 identifies and removes duplicate detections, keeping only those detections with the highest confidence scores among each set of duplicate detections. If two or more detections have same high confidence score, then the results extraction module 318 determines which one has the best bounding box parameters, which encompass all the request requirements from the user and retains the detection, eliminating other duplicate detections of same kind. In one embodiment, the detections with the high confidence score are detected using a method such as Non-Maximum Suppression (NMS) technique. The NMS technique removes or suppresses other bounding boxes or detections with a significant intersection over union that overlap with the selected box. The process is repeated with the next highest confidence bounding box until all boxes are considered. The NMS technique effectively eliminates redundant or overlapping detections by retaining only the bounding box with the highest confidence score. This refinement process enhances the clarity and accuracy of the final labeled output, ensuring that the detections meet the actual requirements of the user obtained from the text instructions or the example images.

The system 300 can be implemented on diverse computing platforms, including cloud-based environments, mobile devices, and edge computing systems. The system 300 effectively supports real-time applications such as industrial inspection, medical image analysis, and interactive visual assistance via multimodal chat services.

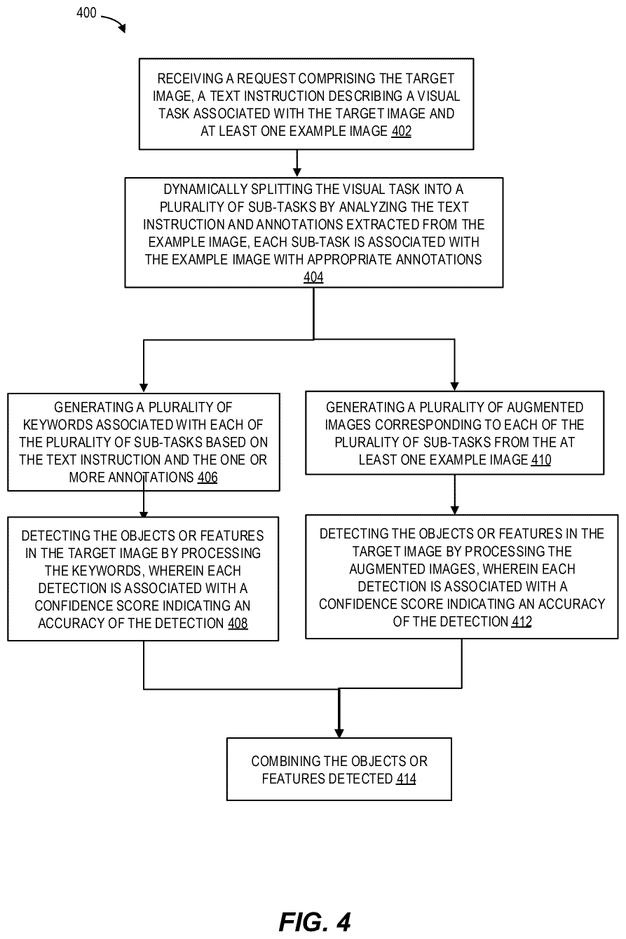

FIG. 4 depicts a flowchart 400 illustrating the method for detecting one or more objects or features in a target image according to an illustrative embodiment. The method may be executed on a computing device that includes a processor and a memory storing program instructions.

At block 402, the computing device receives a request including text instructions, a target image, and at least one example image. The text instructions may be provided in a natural language format without the need for specific formatting. The example image includes visual information relevant to the described visual task.

At block 404, the task planner module 308 dynamically splits the visual task into multiple sub-tasks. The task planner module 308 uses a large language model (LLM) to analyze the text instructions and annotations extracted from the example image to create these sub-tasks. Each sub-task combines both textual instructions and visual examples or few-shot images to guide subsequent processing.

At block 406, keywords are generated corresponding to each sub-task. To generate keywords, the method extracts descriptive terms from the text instructions and annotations using the LLM. Visual examples or few-shot images are created from the example image using labelling or annotation of the objects or feature relevant to the particular sub-task.

The method detects objects or features in the target image using two parallel detection approaches. The first approach, vocabulary-based object detection, utilizes keywords to identify and detect objects or features based on semantic cues, as shown in block 408. The second approach, augmented image or visual few-shot detection, compares the augmented images or visual few-shot detection generated in block 410 with the target image using a large vision model (LVM), which operates in coordination with the LLM in a multimodal configuration, as shown in block 412. Each detection from both methods generates a confidence score indicating detection accuracy.

At block 414, the computing device combines the detections or results from the vocabulary-based detection and the visual few-shot detection. This can include identifying duplicate or overlapping detections and applying techniques such as non-maximum suppression (NMS) to retain only the highest-confidence detections among duplicate detections. The final output from this block is a clearly labeled target image identifying detected objects or features.

The method described in FIG. 4 allows efficient object and feature detection with reduced (e.g., minimal) manual input and does not require extensive retraining for different visual tasks. It provides flexibility and accuracy, particularly beneficial in dynamic environments and user-specific applications.

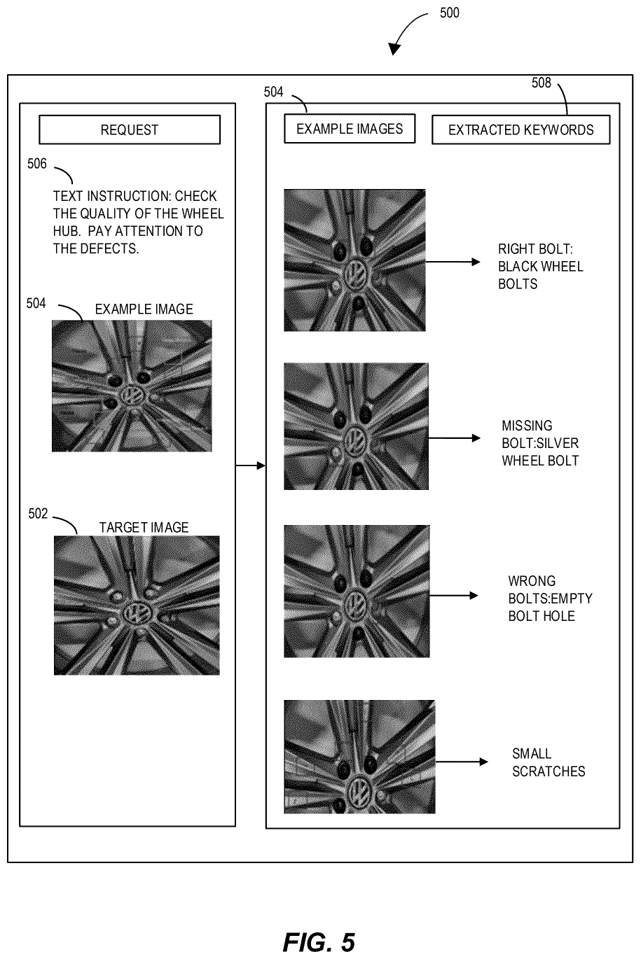

FIG. 5 is an exemplary diagram 500 illustrating dynamically splitting a visual inspection task into multiple simpler sub-tasks, as implemented in the present disclosure. A user initially provides a request that includes a target image 502, an example image 504, and a plain-language text instruction 506 such as “Check the quality of the wheel hub. Pay attention to defects.” The system 300 analyzes the provided text instruction 506 along with annotations from the example image to automatically divide the inspection task into multiple distinct sub-tasks. Each sub-task is illustrated clearly with corresponding example images (or few shots), including extracted keywords 508 such as “Right bolt”, “Missing bolt”, Wrong Bolt” representing objects and keywords such as “small scratches” for the features or defects to be detected, specific to the sub-task. Further the system 300 generates feature description associated with each keyword, such as “identifying black wheel bolts”, “missing silver wheel bolts”, “empty bolt holes”, and “small surface scratches”. Illustrating sub-tasks with corresponding example images and extracted keywords, along with specific feature descriptions such as identifying black wheel bolts or missing bolts, provides clear context. This detailed context helps the system 300 accurately understand what needs to be detected, greatly enhancing accuracy and efficiency in defect detection.

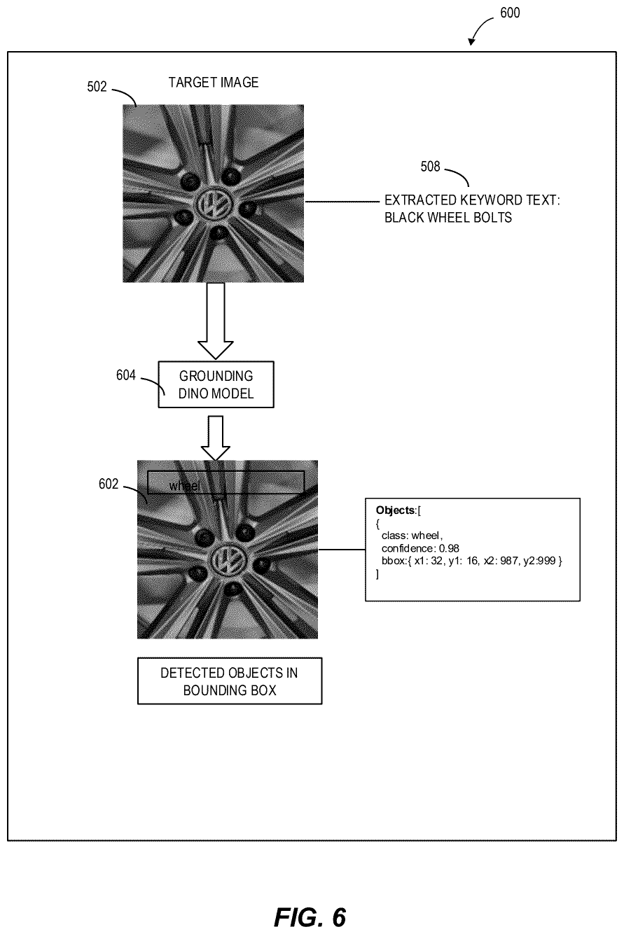

FIG. 6 is an exemplary diagram 600 illustrating the generation of keywords for each sub-task using the system 300, in accordance with an exemplary embodiment. For each sub-task identified earlier, the system 300 extracts keywords 508 from the provided text instruction and annotated example images. For example, it extracts precise terms like “black wheel bolts,” “silver wheel bolt,” “empty bolt hole,” and “small scratches.” These keywords are generated automatically by analyzing visual and textual information using large language and large vision models operating in a multimodal configuration. Using the extracted keywords 508 and the target image 502 as input to a vocabulary object detection model 604 (such as a Grounding DINO (Self-Distillation with NO Labels) Model), objects in the target image 502 can be detected. In practice, employing a large bounding box 602 encompassing multiple relevant features, such as all bolts on a wheel, provides comprehensive visual context. This broad context enhances the ability of the system 300 to accurately and efficiently detect and classify specific defects or features during the detection phase.

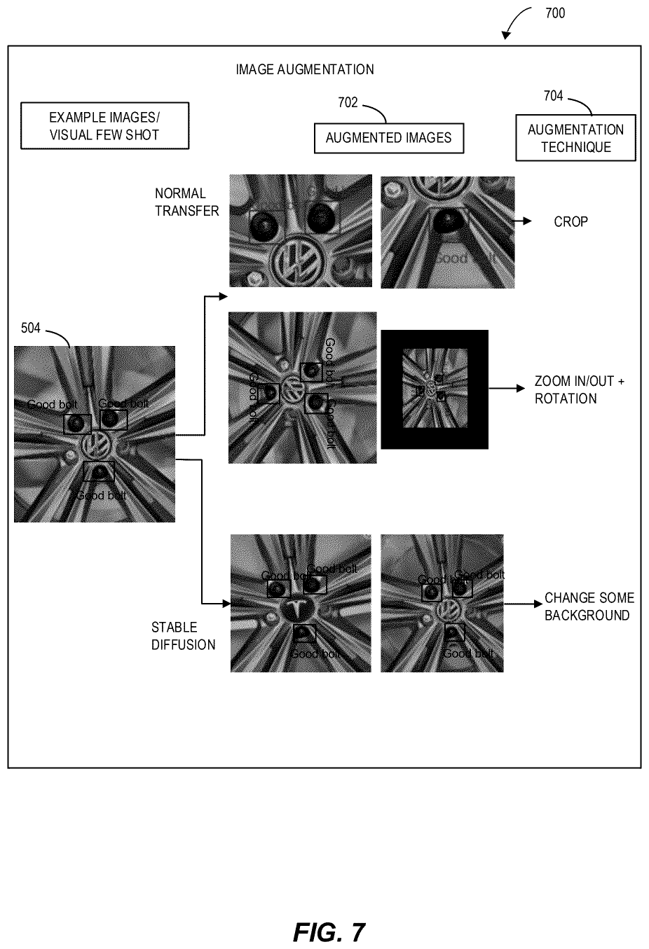

FIG. 7 is an exemplary diagram 700 illustrating the generation of multiple augmented images 702 from an example image 504 associated with a sub-task using various image augmentation techniques 704. Image augmentation techniques using normal transfer methods such as cropping, zooming, and rotating, and advanced methods like stable diffusion are applied automatically to the example image associated with the sub-task. Normal transfer methods create simple variations such as different zoom levels or rotated views, while stable diffusion allows for more complex changes like altering backgrounds or logos. Changing backgrounds or logos is particularly advantageous for verifying visual consistency and detecting subtle variations or errors, such as incorrect logos or unusual background elements. Generating these multiple augmented images allows the system 300 to robustly detect objects or features even when viewing conditions differ significantly from the original example, thereby enhancing detection accuracy and reliability.

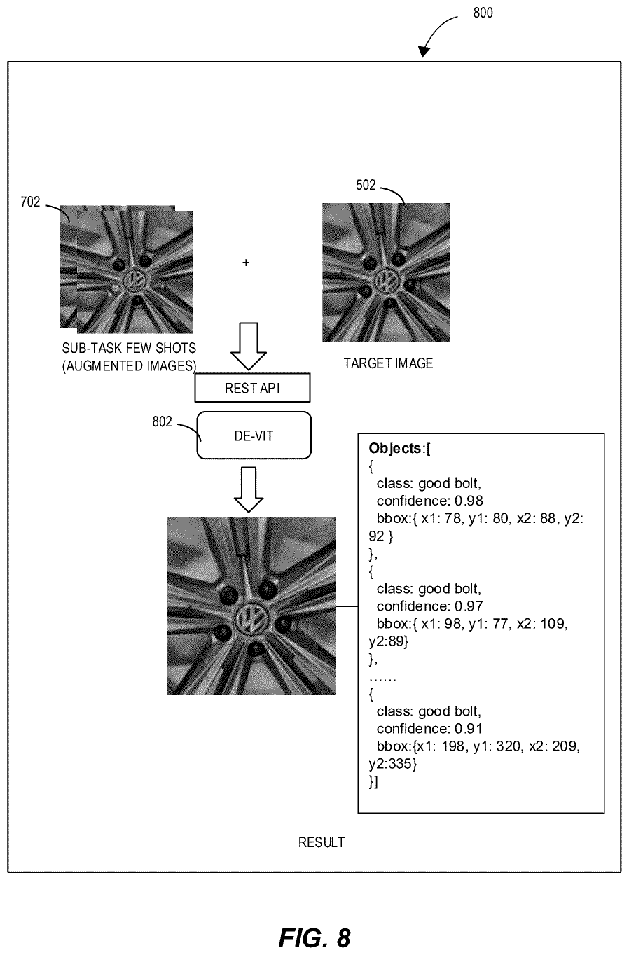

FIG. 8 is an exemplary diagram 800 illustrating the detection of objects or features in the target image 502 using the augmented images 702. The augmented example images 702 and the target image 502 are processed using a visual few-shot detection model 802 like DE-ViT (a few-shot object detection method that leverages pre-trained vision transformers (ViTs) to detect everything with limited training data). For example, in an industrial inspection scenario, the visual few-shot detection model can identify and label instances of bolts as “good bolts” (as shown in FIG. 8) and/or “defective bolts,” each with associated confidence scores. In parallel, the vocabulary-based detection method of FIG. 6 utilizes concise extracted keywords such as “black wheel bolts” to detect objects. The system 300 may combines results from both methods, such as by applying a Non-Maximum Suppression (NMS) method that removes invalid or duplicate objects/detections and/or retains the versions of duplicate objects with are more accurate or that have the highest confidence values. Using NMS can provide clean, accurate, and interpretable detection outcomes, significantly improving the overall quality and effectiveness of visual inspections.

### Conclusion

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Embodiments of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement embodiments of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method for detecting one or more objects or features in a target image, the method
comprising:
receiving a request comprising the target image, a text instruction describing a visual task associated with the target image, and at least one example image;
dynamically splitting the visual task into a plurality of sub-tasks by analyzing the text instruction and one or more annotations extracted from the at least one example image;
generating one or more keywords associated with each of the plurality of sub-tasks based on the text instruction and the one or more annotations;
generating a plurality of augmented images corresponding to each of the plurality of sub-tasks from the at least one example image;
detecting the one or more objects or features in the target image by separately processing the target image based on: the plurality of augmented images, and the one or more keywords, wherein each detection is associated with a confidence score indicating an accuracy of the detection; and
combining the one or more objects or features.

2. The method of claim 1, wherein dynamically splitting the visual task comprises analyzing the text instruction and the one or more annotations extracted from the at least one example image using a large language model (LLM).

3. The method of claim 2, wherein generating the one or more keywords comprises extracting terms relevant to the one or more objects or features from the text instruction and the one or more annotations extracted from the at least one example image using the LLM.

4. The method of claim 1, wherein extracting the one or more annotations from the at least one example image comprises using a large vision model (LVM) operating within a multimodal configuration that includes the LVM and the LLM.

5. The method of claim 1, wherein detecting the one or more objects or features in the target image based on the one or more keywords includes performing text-to-target detection on the target image using a vocabulary-based object detection method.

6. The method of claim 1, wherein generating the plurality of augmented images from the at least one example image includes applying at least one image augmentation technique.

7. The method of claim 4, wherein detecting the one or more objects or features in the target image includes processing the plurality of augmented images and the target image using the LVM and the LLM operating in the multimodal configuration, wherein each detected object or feature is assigned with one or more annotations and a confidence score.

8. The method of claim 7, wherein detecting the one or more objects or features in the target image further includes processing the target image based on the one or more annotations, the one or more keywords and the text instruction using the LLM and the LVM operating in the multimodal configuration.

9. The method of claim 1, further comprising combining the one or more objects or features, by identifying and removing duplicate objects and/or retaining objects having a highest confidence score among the one or more objects.

10. The method of claim 9, wherein combining the one or more objects or features includes applying non-maximum suppression (NMS).

11. A computing device comprising:
a processor; and
a memory in communication with the processor, with one or more computer program instructions stored on the memory, the computer program instructions, when executed by the processor, cause the computing device to perform operations comprising:
receiving a request comprising a target image, a text instruction describing a visual task associated with the target image and at least one example image;
dynamically splitting the visual task into a plurality of sub-tasks by analyzing the text instruction and one or more annotations extracted from the at least one example image;
generating one or more keywords associated with each of the plurality of sub-tasks based on the text instruction and the one or more annotations;
generating a plurality of augmented images corresponding to each of the plurality of sub-tasks from the at least one example image;
detecting one or more objects or features in the target image by separately processing the target image based on: the plurality of augmented images, and the one or more keywords, wherein each detection is associated with a confidence score indicating an accuracy of the detection; and
combining the one or more objects or features.

12. The computing device of claim 11, wherein the computer program instructions further cause the computing device to: dynamically split the visual task into the plurality of sub-tasks by analyzing the text instruction and the one or more annotations obtained from the at least one example image using a large language model (LLM).

13. The computing device of claim 11, wherein the computer program instructions further cause the computing device to: extract the one or more annotations from the at least one example image using a large vision model (LVM) operating in a multimodal configuration that includes the LVM and the LLM.

14. The computing device of claim 11, wherein the computer program instructions further cause the computing device to: generate the one or more keywords by extracting terms relevant to the one or more objects or features from the text instruction and the one or more annotations extracted from the at least one example image using the LLM.

15. The computing device of claim 11, wherein the computer program instructions further cause the computing device to: generate the plurality of augmented images from the at least one example image by applying at least one image augmentation technique.

16. The computing device of claim 11, wherein the computer program instructions further cause the computing device to: detect the one or more objects or features in the target image by processing the plurality of augmented images and the target image using the LVM and the LLM operating in a multimodal configuration.

17. A computer program product for detecting one or more objects or features in a target image, the computer program product comprising:
one or more computer-readable storage devices and program instructions stored on at least one of the one or more computer-readable storage devices, the program instructions executable by a processor, the program instructions comprising:
program instructions to receive a request comprising a target image, a text instruction describing a visual task associated with the target image and at least one example image;
program instructions to dynamically split the visual task into a plurality of sub-tasks by analyzing the text instruction and one or more annotations extracted from the at least one example image;
program instructions to generate one or more keywords associated with each of the plurality of sub-tasks based on the text instruction and the one or more annotations;
program instructions to generate a plurality of augmented images corresponding to each of the plurality of sub-tasks from the at least one example image;
program instructions to detect one or more objects or features in the target image by separately processing: the plurality of augmented images, and the one or more keywords, wherein each detection is associated with a confidence score indicating an accuracy of the detection; and
program instructions to combine the one or more objects or features.

18. The computer program product of claim 17, wherein the program instructions further comprise instructions to perform detection of the one or more objects or features in the target image by processing the plurality of augmented images and the target image using a large vision model (LVM) operating within a multimodal configuration that includes the LVM and a large language model (LLM).

19. The computer program product of claim 17, wherein the program instructions further comprise instructions to perform a vocabulary-based object detection method to detect the one or more objects or features in the target image based on the one or more keywords.

20. The computer program product of claim 17, wherein:
the program instructions further comprise instructions to combine the one or more objects or features, by identifying and removing duplicate objects and/or retaining objects having a highest confidence score among the one or more objects,
wherein combining the one or more objects or features includes applying a non-maximum suppression (NMS) technique that at least removes redundant objects.
